(19) United States
(12) Patent Application Publication
(10) Pub. No.: US 2017/0241883 A1
(43) Pub. Date: Aug. 24, 2017

(54) ANALYSIS APPARATUS AND ANALYSIS METHOD USING PARTICLE METHOD

(71) Applicant: FUJI XEROX CO., LTD., Tokyo (JP)

(72) Inventor: Ryosuke TAKAHASHI, Kanagawa (JP)

(73) Assignee: FUJI XEROX CO., LTD., Tokyo (JP)

(21) Appl. No.: 15/203,321

(22) Filed: Jul. 6, 2016

(30) Foreign Application Priority Data
Feb. 23, 2016 (JP) 2016-031936

(51) Int. Cl. G01N 11/10; G01N 15/10

(52) U.S. Cl. CPC G01N 11/10; G01N 15/10

(57) ABSTRACT

An analysis apparatus includes a detector and a determination unit. The detector detects, for a target particle, a direction of a surface that is in proximity to the target particle. The determination unit determines the target particle to be a surface particle in a case where the number of other particles within a predetermined region extending in the direction of the surface is smaller than a threshold.

### CROSS-REFERENCE TO RELATED APPLICATIONS

This application is based on and claims priority under 35 USC 119 from Japanese Patent Application No. 2016-031936 filed Feb. 23, 2016.

### BACKGROUND

### Technical Field

The present invention relates to an analysis apparatus and an analysis method using a particle method.

### SUMMARY

According to an aspect of the invention, there is provided an analysis apparatus including a detector and a determination unit. The detector detects, for a target particle, a direction of a surface that is in proximity to the target particle. The determination unit determines the target particle to be a surface particle in a case where the number of other particles within a predetermined region extending in the direction of the surface is smaller than a threshold.

### BRIEF DESCRIPTION OF THE DRAWINGS

An exemplary embodiment of the present invention will be described in detail based on the following figures, wherein:

FIG. 1 is a block diagram illustrating a configuration of an analysis apparatus according to an exemplary embodiment of the present invention;

FIG. 2 is a flowchart illustrating an operation of the analysis apparatus according to an exemplary embodiment of the present invention;

FIG. 3 is a flowchart illustrating in detail a surface particle determination process in a step;

FIGS. 4A to 4D are schematic diagrams for describing a surface particle determination method in an exemplary embodiment of the present invention;

FIG. 5 is a schematic diagram for describing the surface particle determination method in an exemplary embodiment of the present invention;

FIG. 6 is a diagram illustrating the result of determination of surface particles by the analysis apparatus according to an exemplary embodiment of the present invention;

FIGS. 7A to 7D are diagrams illustrating examples of numerical analyses using the analysis apparatus according to an exemplary embodiment of the present invention; and

FIG. 8 is a diagram illustrating the result of determination of surface particles by an analysis apparatus according to a comparative example.

### DETAILED DESCRIPTION

A particle method is a numerical analysis method for a continuum using particles and is a method in which a continuum is represented by a finite number of particles and a behavior of the continuum is calculated on the basis of the movements of the particles.

As a representative particle method, the moving particle semi-implicit (MPS) method, which is a numerical analysis method for an incompressible flow, is used. In the MPS method, the particle number density is assumed to be constant as an incompressibility condition, and a Poisson equation of pressure is derived on the basis of the condition. A free surface is determined in accordance with a decrease in the particle number density. Therefore, the MPS method is favorable in that the form of the surface need not be drawn, fluid fragmentation and coalescence are easily calculated, a large deformation of the interface is easily handled, and troublesome grid generation need not be performed, for example. In a numerical analysis using the MPS method, it is determined whether particles for calculation are present on the surface of a fluid or in the fluid, and calculation targets of interaction forces, such as the pressure gradient and the surface tension, are determined. Therefore, it is necessary to perform surface particle determination with high accuracy.

A method is currently used in which the number density that represents the number of other particles present in the vicinity of a target particle is used to determine the target particle to be a surface particle that is present on the surface of the continuum if the number density is equal to or smaller than a threshold.

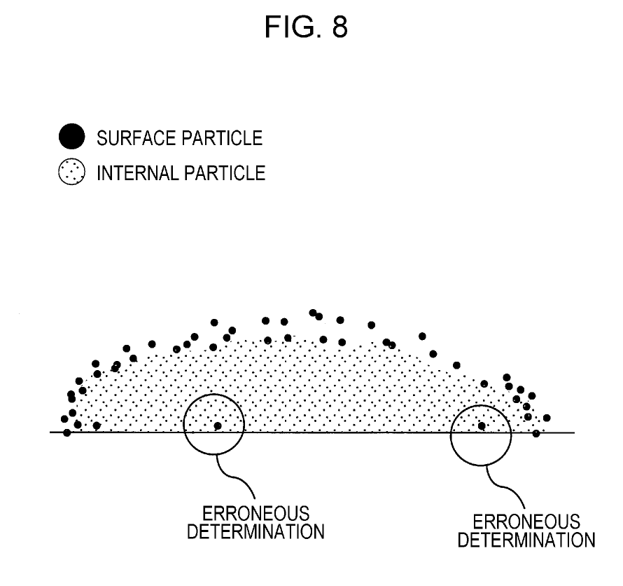

With this method, however, a particle that is not present on the surface may be determined to be a surface particle, the determination accuracy varies depending on the particle coordinates or the form of the droplet, and erroneous determination occurs with a probability of about 3 to 30%. FIG. 8 relates to the wettability of a droplet and illustrates the result of determination as to whether particles are surface particles by using the number density, and particles determined to be surface particles and particles determined to be internal particles that are not present on the surface are illustrated. Accordingly, in the above-described determination method, an internal particle may be erroneously determined to be a surface particle.

An exemplary embodiment of the present invention has been made in view of the above-described case and is described in detail with reference to the drawings.

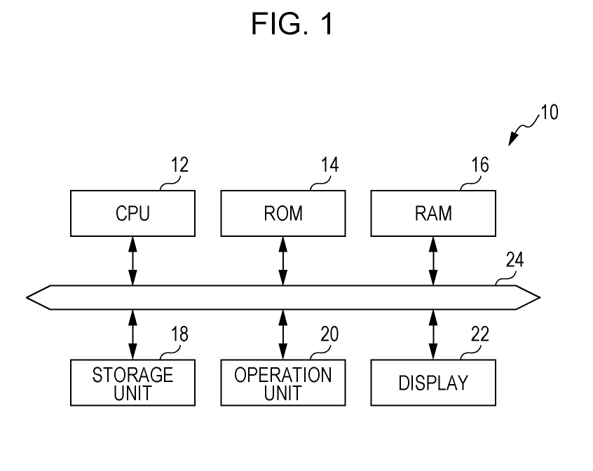

FIG. 1 is a block diagram illustrating an overall configuration of an analysis apparatus 10 according to an exemplary embodiment of the present invention.

As illustrated in FIG. 1, the analysis apparatus 10 includes a central processing unit (CPU) 12, a read-only memory (ROM) 14, a random access memory (RAM) 16, a storage unit 18, an operation unit 20, and a display 22, which are connected to a bus 24.

The CPU 12 performs a predetermined process in accordance with a program stored in the ROM 14 or in the storage unit 18 and controls operations of the units in the analysis apparatus 10.

In this exemplary embodiment, a description is given while assuming that the CPU 12 reads and executes the program stored in the ROM 14 or in the storage unit 18. However, the program, which is stored in a storage medium such as a compact disc read-only memory (CD-ROM), may be provided to the CPU 12, or the program may be provided via a communication apparatus not illustrated.

The ROM 14 is a nonvolatile read-only storage device formed of a semiconductor device or the like.

The RAM 16 is a volatile memory formed of a semiconductor device or the like and is used as a work area when the CPU 12 executes the program.

The storage unit 18 is a bulk memory, such as a hard disk drive, and stores the program to be read by the CPU 12.

The operation unit 20 includes a touch sensor, a keyboard, a mouse, and so on, receives a user operation, and supplies a signal corresponding to the operation to the CPU 12.

The display 22 is an output unit, such as a monitor, that displays various types of information in accordance with control performed by the CPU 12.

In this exemplary embodiment, a fluid is analyzed on the basis of a particle method (MPS method) by using the analysis apparatus 10. In the MPS method, parameters are input to the analysis apparatus 10 as initial values, the parameters including parameters relating to the material properties, such as the particle density and the kinematic viscosity coefficient, parameters relating to the external forces, such as the gravitational acceleration, parameters, such as the particle velocities and the particle coordinates upon initial disposition, and parameters based on which the form of a cone C that is used in surface particle determination described below is determined.

The analysis apparatus 10 performs a predetermined calculation using the input parameters by the CPU 12 executing the program stored in the storage unit 18 and updates the flow velocities and the coordinates of particles at predetermined time intervals.

Now, an operation of the analysis apparatus 10 in an exemplary embodiment of the present invention is described in detail.

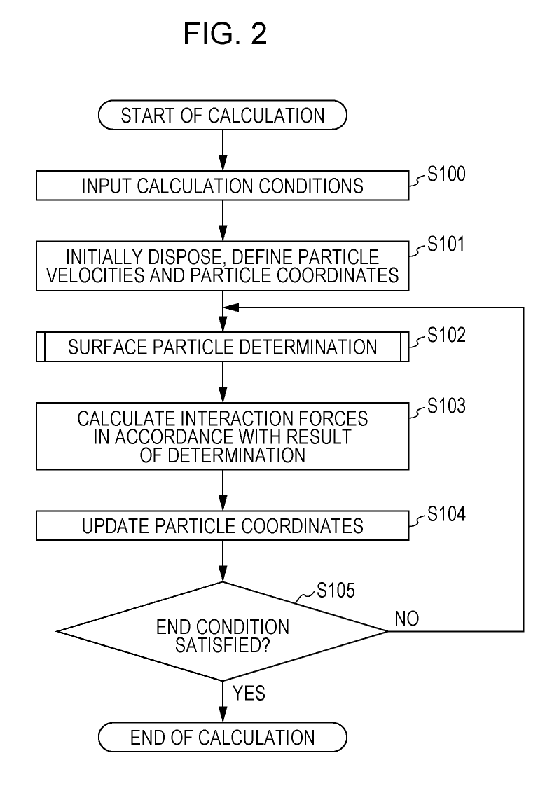

FIG. 2 is a flowchart illustrating an operation of the analysis apparatus 10 in an exemplary embodiment of the present invention.

In step S100, calculation conditions are input through an input operation by an operator using the operation unit 20. Specifically, parameters relating to the material properties, such as the particle density and the kinematic viscosity coefficient, parameters relating to the external forces, such as the gravitational acceleration, parameters relating to the boundary conditions, and so on are input, and an analysis is performed.

In step S101, target particles, which are determination targets, are initially disposed in a predetermined form, the particle velocities, the particle coordinates, and so on are defined, and the parameters are input through an input operation by the operator using the operation unit 20.

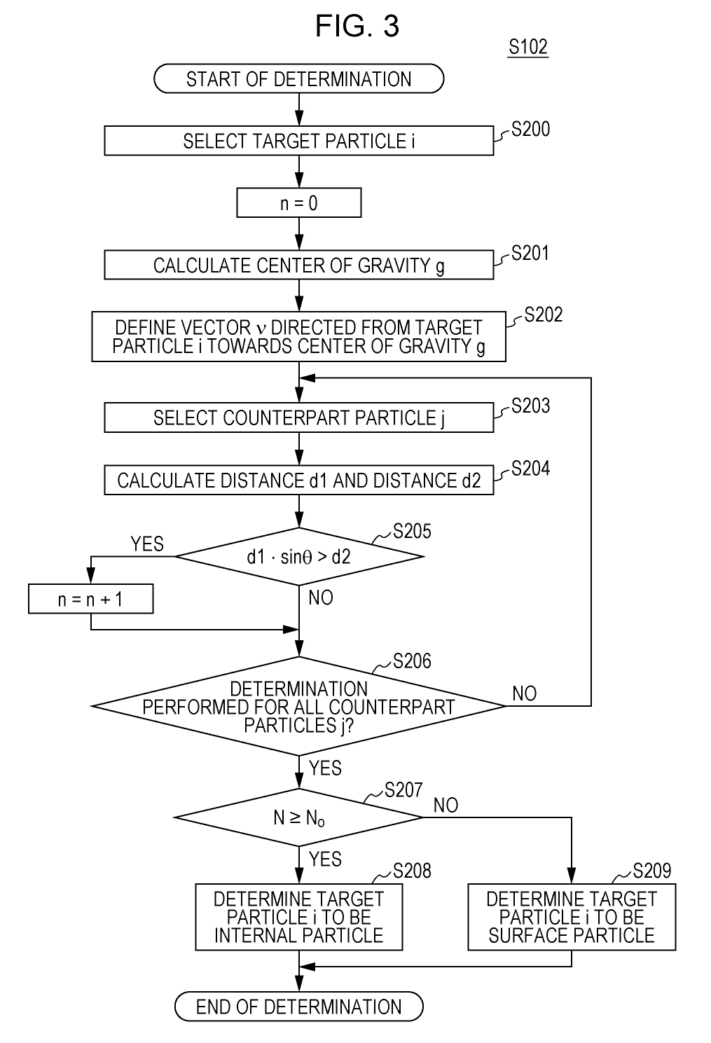

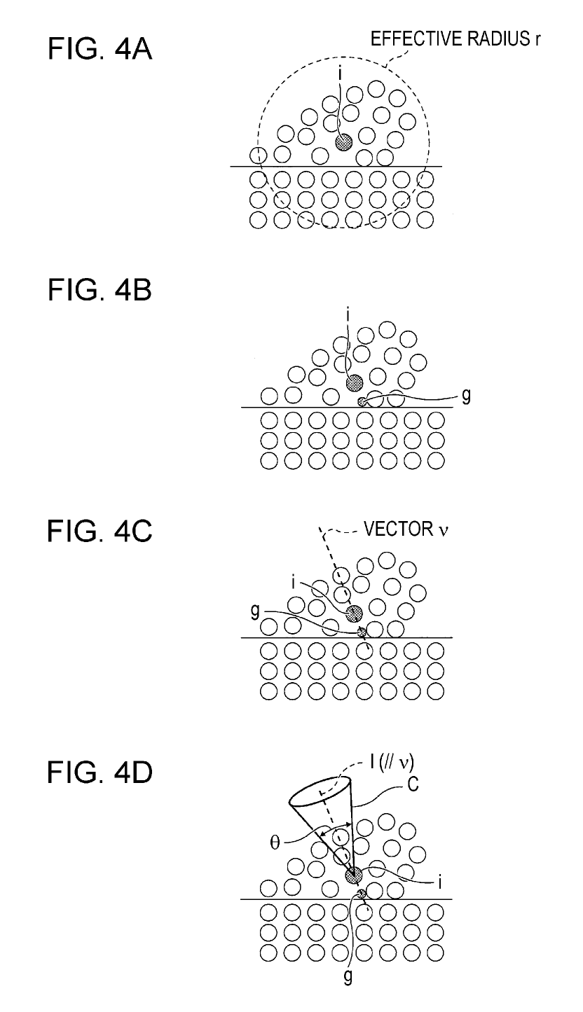

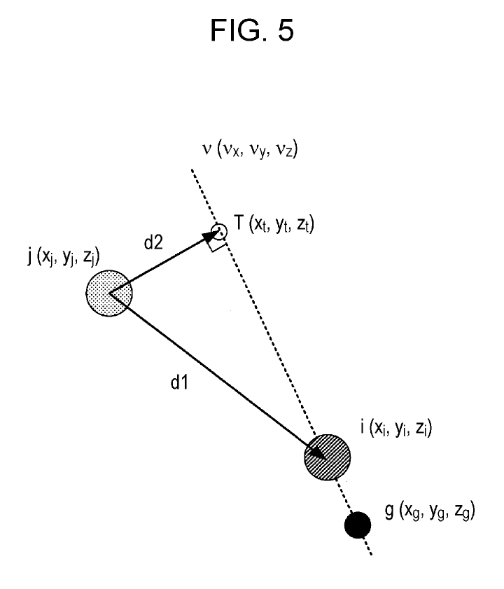

In step S102, a surface particle determination process for determining whether the target particles are surface particles is performed. The surface particle determination process is described in detail with reference to FIG. 3 to FIG. 5. FIG. 3 is a flowchart illustrating in detail the surface particle determination process in step S102. FIGS. 4A to 4D and FIG. 5 are schematic diagrams for describing a surface particle determination method.

In step S200, a target particle i, which is a determination target, is selected.

In step S201, the center of gravity g is calculated from the average of the coordinates of other particles present within an effective radius r of the target particle i, as illustrated in FIGS. 4A and 4B. Here, the effective radius r may be set to any value that indicates a predetermined range, and the center of gravity g is calculated from the average of the coordinates of other particles present within the predetermined range.

In step S202, a vector ν directed from the target particle i towards the center of gravity g is defined, as illustrated in FIG. 4C. The direction of the vector ν indicates the surface direction relative to the target particle i, and the vector ν is a normal vector in the surface direction.

Subsequently, a cone C having a line parallel to the vector ν as the rotation axis l, the target particle i as the vertex, and any central angle θ is formed, as illustrated in FIG. 4D. Then, the number of other particles present within the cone C is calculated. Specifically, the number is calculated in the process in steps S203 to S207 described below.

In step S203, a counterpart particle j is selected from among counterpart particles j that are present in proximity to the target particle i.

In step S204, the distance d1 between the target particle i and the selected counterpart article j is calculated. The distance d1 is represented by using the coordinates (xᵢ, yᵢ, zᵢ) of the center of the target particle i and the coordinates (xⱼ, yⱼ, zⱼ) of the center of the selected counterpart particle j as follows.

d₁=\sqrt{(xᵢ−yⱼ)²+(yᵢ−yⱼ)²+(zᵢ−zⱼ)²}

Next, the distance d2 between the selected counterpart particle j and the vector ν is calculated. Specifically, the distance d2 between the axis l that passes through the center of the target particle i at the coordinates (xᵢ, yᵢ, zᵢ) and extends in a direction represented by the vector ν (νₓ, ν_{y}, ν_{z}) and the center of the selected counterpart particle j at the coordinates (xⱼ, yⱼ, zⱼ) is calculated.

Here, the vector ν (νₓ, ν_{y}, ν_{z}) is a direction vector and is a vector directed from the target particle i towards the center of gravity g, and therefore, the vector ν is represented by using the coordinates (xᵢ, yᵢ, zᵢ) of the center of the target particle i and the coordinates (x_{g}, y_{g}, z_{g}) of the center of gravity g as follows.

νₓ=x_{g}−xᵢ

ν_{y}=y_{g}−yᵢ

ν_{z}=z_{g}−zᵢ

The distance d2 is the length of the perpendicular from the selected counterpart particle j to the vector ν. Therefore, when the coordinates of the foot of the perpendicular on the vector ν (point T) is represented by (xₜ, yₜ, zₜ), the perpendicular extending from the center of the selected counterpart particle j at the coordinates (xⱼ, yⱼ zⱼ) to the vector ν, a line that passes through the center of the target particle i at the coordinates (xᵢ, yᵢ, zᵢ) and has the direction vector (νₓ, ν_{y}, ν_{z}) is expressed by the following equations using a parameter t.

xₜ=xᵢ+νₓt

yₜ=yᵢ+ν_{y}t

zₜ=zᵢ+ν_{z}t

Therefore, on the basis of the coordinates (xⱼ, yⱼ, zⱼ) of the center of the selected counterpart particle j and the point T (xₜ, yₜ, zₜ), a vector jT directed from the selected counterpart particle j towards the point T is calculated as follows.

((xᵢ+νₓt)−xⱼ,(yᵢ+ν_{y}t)−yⱼ,(zᵢ+ν_{z}t)−zⱼ)

The vector jT is orthogonal to the vector ν, and therefore, the inner product of these vectors is equal to zero, which is expressed as follows.

$${v}_{x} \{ ( {x}_{i} + {v}_{x} t ) - {x}_{j} \} + {v}_{y} \{ ( {y}_{i} + {v}_{y} t ) - {y}_{j} \} + {v}_{z} \{ ( {z}_{i} + {v}_{z} t ) - {z}_{j} \} = 0$$

$$t = \frac{{v}_{x} ( {x}_{i} - {x}_{j} ) + {v}_{y} ( {y}_{i} - {y}_{j} ) + {v}_{z} ( {z}_{i} - {z}_{j} )}{{v}_{x}^{2} + {v}_{y}^{2} + {v}_{z}^{2}}$$

The distance d2 between the selected counterpart particle j and the vector ν is expressed by using the coordinates (xⱼ, yⱼ, zⱼ) of the center of the selected counterpart particle j and the point T (xₜ, yₜ, zₜ) as follows.

d₂=\sqrt{(xₜ−xⱼ)²+(yₜ−yⱼ)²+(zₜ−zⱼ)²}

As described above, the distance d1 and the distance d2 are calculated by inputting the coordinates of the center of the target particle i, the coordinates of the center of the selected counterpart particle j, and the coordinates of the center of gravity g as parameters.

In step S205, determination as to whether the selected counterpart particle j satisfies a condition d1·sin θ>d2 is performed. If the condition is satisfied (Yes in step S205), the selected counterpart particle j is counted as a particle that is present within the cone C, and the flow proceeds to step S206. If the condition is not satisfied (No in step S205), the selected counterpart particle j is not present within the cone C and is not counted as a particle that is present within the cone C, and the flow proceeds to step S206.

In step S206, it is determined whether the above determination has been performed for all of the counterpart particles j. If the determination has been performed for all of the counterpart particles j (Yes in step S206), the flow proceeds to step S207. Otherwise (No in step S206), the flow returns to step S203.

In step S207, it is determined whether the number of the counterpart particles j that are counted as particles present within the cone C is equal to or larger than a threshold Nₒ. If the number N is equal to or larger than the threshold Nₒ (Yes in step S207), the target particle i is determined to be an internal particle (step S208). If the number N is smaller than the threshold Nₒ (No in step S207), the target particle i is determined to be a surface particle (step S209).

Referring back to FIG. 2, in step S103, interaction forces, such as the pressure gradient and the surface tension, are calculated in accordance with the result of determination. Specifically, a predetermined parameter is input as the pressure in a case where the target particle i is determined to be an internal particle, and the pressure is set to zero in a case where the target particle i is determined to be a surface particle. Then, interaction forces are calculated.

In step S104, the particle coordinates are updated on the basis of the force caused by the pressure gradient.

In step S105, it is determined whether an end condition is satisfied, that is, whether a specified calculation time has passed, for example. If the end condition is satisfied (Yes in step S105), the flow ends. If the end condition is not satisfied (No in step S105), the flow returns to step S102.

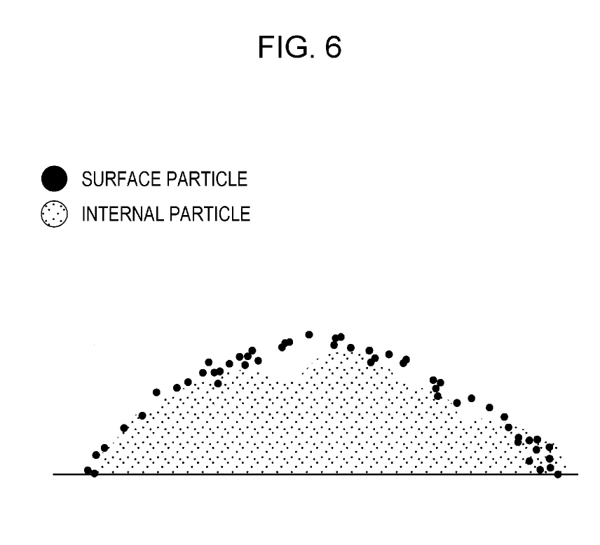

FIG. 6 illustrates the result of determination of surface particles of a droplet according to the above-described exemplary embodiment of the present invention, and particles determined to be surface particles and particles determined to be internal particles that are not present on the surface are illustrated. As illustrated in FIG. 6, robust determination is enabled for a droplet form with the above-described determination method, and the erroneous determination rate is significantly decreased to about 0 to 2%.

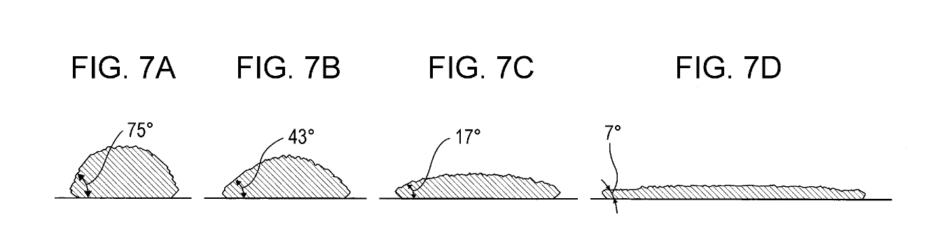

FIGS. 7A to 7D are diagrams illustrating examples of simulation analyses based on the particle method performed by using the analysis apparatus 10 according to the exemplary embodiment of the present invention. FIGS. 7A to 7D illustrate the results of simulation analyses displayed while the wettability of a droplet is set such that the contact angle θ of the droplet form is set to 75° in FIG. 7A, 43° in FIG. 7B, 17° in FIG. 7C, and 7° in FIG. 7D.

In a hydrophilic condition, the balance of the surface tension at a three-phase interface needs to be handled more precisely, and therefore, surface particles need to be determined with high accuracy. According to the related art, it is not possible to reproduce a form having a contact angle of less than 30° or so in a simulation analysis. According to the exemplary embodiment of the present invention, it is possible to reproduce a form in a hydrophilic condition, that is, a form having a contact angle down to 7°.

Note that particles that are present within a certain distance from a wall surface among particles determined to be surface particles are determined to be three-phase interface particles and may be used to calculate the interfacial tension upon calculation of the wetting behavior. At this time, in a case where the height of the fluid in proximity to the three-phase interface is low, erroneous determination of three-phase interface particles tends to occur. In this case, the surface particle determination algorithm is further used in a direction parallel to the wall surface to determine whether the particles are three-phase interface particles.

In this exemplary embodiment, in the surface particle determination process, the number of the counterpart particles j having the center points that are within the cone C is used as the threshold to determine whether the target particle i is a surface particle; however, the determination is not limited to this. The number of the counterpart particles j that are entirely or partially included in the cone C may be used as the threshold, or the volume of the counterpart particles j that are included in the cone C may be used as the threshold.

In this exemplary embodiment, the central angle and the height of the cone C are set as desired; however, the central angle and the height may be set to different values depending on the purpose of calculation. That is, as the central angle decreases, more precise determination is enabled. As the height increases, the determination accuracy increases.

In this exemplary embodiment, determination of a surface particle is performed on a 3D fluid by using, as the threshold, the number of the counterpart particles j that are counted as particles present within the cone C. In a case of 2D determination, a triangle that has the target particle i as the vertex, is symmetric about the axis l that is a straight line parallel to the vector ν directed from the target particle i towards the center of gravity g, and has any vertex angle is used to perform determination of a surface particle while the number of the counterpart particles j counted as particles present within the triangle is used as the threshold.

The above-described exemplary embodiment of the present invention is used in a simulation or the like based on the particle method; however, an exemplary embodiment of the present invention is not limited to the above-described exemplary embodiment, and various modifications may be made. Further, the above-described exemplary embodiment of the present invention may be used in combination with the number density method.

In this exemplary embodiment, the method is described in which a fluid is represented by particles, and a behavior of the fluid is calculated on the basis of the movements of the particles. However, this exemplary embodiment is not limited to the method and may be applied to continua, such as a pulverulent body and a solid body.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An analysis apparatus comprising:
a detector that detects, for a target particle, a direction of a surface that is in proximity to the target particle; and
a determination unit that determines the target particle to be a surface particle in a case where the number of other particles within a predetermined region extending in the direction of the surface is smaller than a threshold.

2. The analysis apparatus according to claim 1, wherein
the detector includes
a calculator that calculates a center of gravity from an average of coordinates of other particles present within a predetermined range from the target particle, and
a vector setting unit that sets a vector connecting the target particle with the center of gravity.

3. The analysis apparatus according to claim 2, wherein
the determination unit determines the target particle to be a surface particle in a case where the number of other particles within a cone is smaller than a threshold, the cone having the target particle as a vertex, a straight line parallel to the vector as an axis, and any central angle.

4. The analysis apparatus according to claim 2, wherein
the determination unit determines the target particle to be a surface particle in a case where the number of other particles within a triangle is smaller than a threshold, the triangle having the target particle as a vertex, having a straight line parallel to the vector as an axis, being symmetric about the axis, and having any vertex angle.

5. An analysis method comprising:
detecting, for a target particle, a direction of a surface that is in proximity to the target particle; and
determining the target particle to be a surface particle in a case where the number of other particles within a predetermined region extending in the direction of the surface is smaller than a threshold.
